(19) United States
(12) Patent Application Publication
(10) Pub. No.: US 2007/0174604 A1
(43) Pub. Date: Jul. 26, 2007

(54) SYSTEM AND METHOD FOR CALCULATING AN AVERAGE STARTUP TIME OF A COMPUTER

(75) Inventors: TAN-CHIANG WANG, Tu-Cheng (TW); SHI CHENG, Shenzhen (CN); HAI-HUI WU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/560,842

(22) Filed: Nov. 17, 2006

(30) Foreign Application Priority Data
Jan. 20, 2006 (TW) 95102350

(51) Int. Cl. G06F 15/177; G06F 9/00

(52) U.S. Cl. 713/2

(57) ABSTRACT

A method for calculating an average startup time of a computer includes: predefining a total reboot count; setting a current reboot count; rebooting the computer if the computer is in standard working condition; recording a start time and a finish time of rebooting the computer after the computer is rebooted; calculating a startup time by subtracting the start time from the finish time, calculating an average startup time by utilizing all calculated startup times and the current reboot count; incrementing the current reboot count by a value to update the current reboot count with a new value if the current reboot count does not equal the total reboot count; and rebooting the computer if the computer is in standard working condition. A related system is also disclosed.

### BACKGROUND OF THE INVENTION

1. Field of the Invention

The present invention generally relates to systems and methods for calculating a startup time of a device, and more particularly to a system and method for calculating an average startup time of a computer.

2. Description of Related Art

A computer is usually initialized by executing a basic input output system (BIOS), and must be tested in various ways concerning computer performance before the computer is distributed into the consumer market.

Since additional chips or plug-in cards on the motherboard slows down the startup time of the computer this impedes the computer performance. A short startup time becomes an important performance aspect while people are developing a new computer. An effective equipment/method, used to calculate an average startup time as a normal startup time for the new computer before the new computer is distributed into the consumer market, is needed.

However, there is no effective equipment/method to calculate a normal startup time for a computer before the computer is distributed into the consumer market at present.

What is needed, therefore, is a system and method that calculates an average startup time of a computer, and that can quickly calculate a normal startup time for a computer.

### SUMMARY OF THE INVENTION

A system for calculating an average startup time of a computer in accordance with a preferred embodiment includes a storage device and a calculating module. The storage device is for storing calculation data. The calculating module includes a predefining sub-module, a rebooting sub-module, a calculating sub-module, and an analyzing sub-module. The predefining sub-module is configured for predefining a total reboot count, and for setting a current reboot count. The rebooting sub-module is configured for rebooting the computer if the computer is in standard working condition and the current reboot count does not equal the total reboot count. The analyzing sub-module is configured for analyzing whether the computer is in standard working condition according to standard configuration information of the computer, and for analyzing whether the current reboot count equals the total reboot count. The calculating sub-module is configured for recording a start time and a finish time of rebooting the computer each time the computer is rebooted, for calculating a startup time by subtracting the start time from the finish time, for calculating an average startup time by utilizing all calculated startup times and the current reboot count, and for incrementing the current reboot count by a value to update the current reboot count with a new value if the current reboot count does not equal the total reboot count.

A method for calculating an average startup time of a computer in accordance with a preferred embodiment includes the steps of: predefining a total reboot count; setting a current reboot count; rebooting the computer if the computer is in standard working condition; recording a start time and a finish time of rebooting the computer after the computer is rebooted; calculating a startup time by subtracting the start time from the finish time, calculating an average startup time by utilizing all calculated startup times and the current reboot count; incrementing the current reboot count by a value to update the current reboot count with a new value if the current reboot count does not equal the total reboot count; and rebooting the computer if the computer is in standard working condition.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for calculating an average startup time of a computer in accordance with a preferred embodiment;

FIG. 2 is a schematic diagram of main function sub-modules of a calculating module of the system of FIG. 1;

FIG. 3 is a flowchart of a method for calculating an average startup time of a computer in accordance with a preferred embodiment; and

FIG. 4 is a flowchart of the step S23 of FIG. 3, namely calculating an average startup time of the computer of FIG. 3.

### DETAILED DESCRIPTION OF THE INVENTION

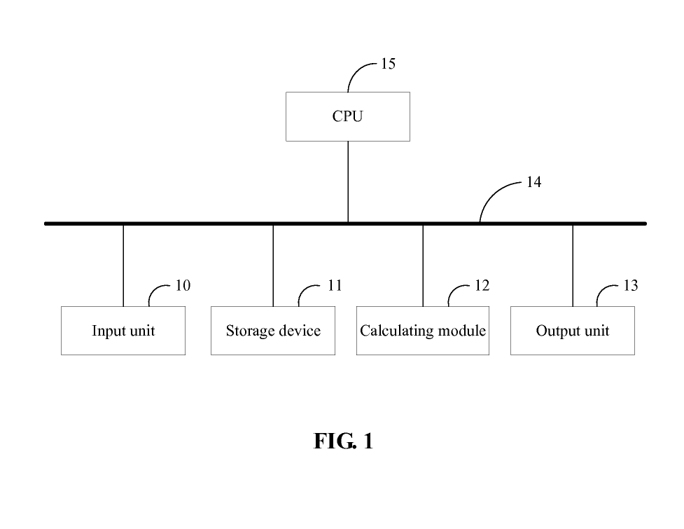

FIG. 1 is a schematic diagram of a hardware configuration of a system for calculating an average startup time of a computer (hereinafter, “the system”) in accordance with a preferred embodiment. The system is connected in the computer, and typically includes: an input unit 10, a storage device 11, a calculating module 12, an output unit 13, a universal serial bus (USB) 14, and a central processing unit (CPU) 15 that is connected with the input unit 10, the storage device 11, the calculating module 12 and, the output unit 13 via the USB 14. The input unit 10 is (i.e., structured and arranged) for predefining calculation parameters. The output unit 13 is configured for displaying an analysis report generated/computed by the calculating module 12. The CPU 15 is for processing data among the input unit 10, the storage device 11, the calculating module 12, and the output unit 13. The USB 14 is for transmitting the data among the input unit 10, the storage device 11, the calculating module 12, and the output unit 13.

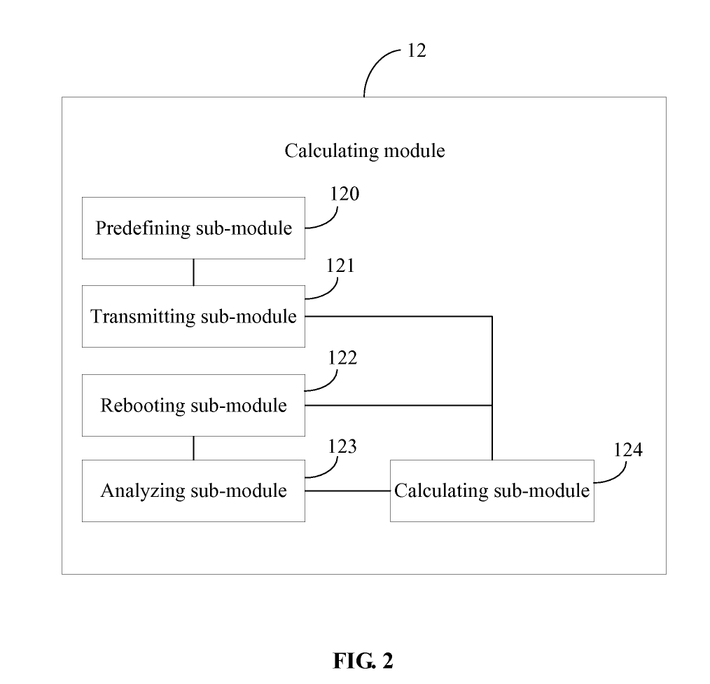

FIG. 2 is a schematic diagram of main function sub-modules of the calculating module 12. The calculating module 12 typically includes a predefining sub-module 120, a transmitting sub-module 121, a rebooting sub-module 122, an analyzing sub-module 123, and a calculating sub-module 124.

The predefining sub-module 120 is configured for prompting a user interface for a user to predefine the calculation parameters via the input unit 10, and also for setting a current reboot count “M” with 1.

The calculation parameters typically include a total reboot count “n”, a first storing path “A” pointing to a first storage space of the storage device 11 that is configured for storing the calculation parameters and standard configuration information of the computer, and a second storing path “B” pointing to a second storage space of the storage device 11 that is configured for storing reboot information. The storage device 11 is configured for storing calculation data, and includes the first storage space and the second storage space. The calculation data includes the calculation parameters, the standard configuration information of the computer, and the reboot information.

The reboot information typically include a start time “t_{M1}” a finish time “t_{M2}”, a startup time “T_{M}” of each time the computer completes rebooting, an average startup time “t_{M}” according to the current reboot count M and all calculated startup times. The configuration information of the computer typically includes working information of the computer drivers.

The transmitting sub-module 121 is configured for saving the calculation parameters and the standard configuration information of the computer into the first storage space according to the first storing path A, for saving the reboot information into the second storage space according to the second storing path B.

The rebooting sub-module 122 is configured for reading the configuring information of the computer before the computer is rebooted, and for rebooting the computer if the computer is in standard working condition.

The analyzing sub-module 123 is configured for analyzing whether the computer is in standard working condition by comparing the configuring information read with the standard configuration information, and for analyzing whether the current reboot count M equals n.

The calculating sub-module 124 is configured for recording the start time t_{M1} and the finish time t_{M2} after the computer is rebooted, for calculating the startup time T_{M} by subtracting recorded t_{M1} from recorded t_{M2}, and for calculating the average startup time t_{M} by dividing the sum of all calculated startup times with the current reboot count M.

The calculating sub-module 124 is further configured for incrementing the current reboot count M by 1 to update the current reboot count M with a new value if the M does not equal n, and for generating the analysis report. The analysis report typically includes the longest startup time in all calculated startup times, the shortest startup time in all calculated startup times, the most recent startup time in averaged startup time, and any error information of the computer.

The transmitting sub-module 121 is further configured for transmitting generated analysis report to the output unit 13 that is configured for displaying the analysis report generated.

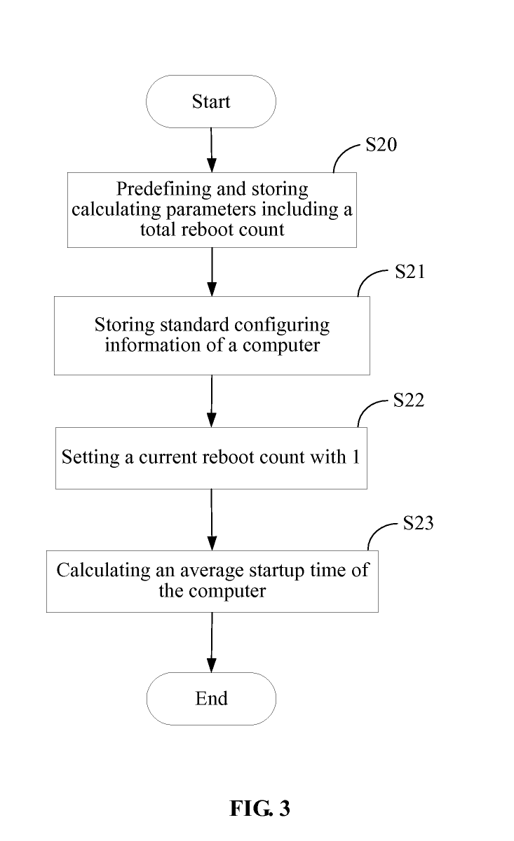

FIG. 3 is a flowchart of a method for calculating an average startup time of a computer by implementing the system as described above. In step S20, the central processing unit (CPU) 15 activates the calculating module 12. The predefining sub-module 120 prompts the user interface for the user to predefine calculation parameters via the input unit 10. The calculation parameters typically include the total reboot count “n”, the first storing path A, and the second storing path B. The transmitting sub-module 121 saves predefined calculation parameters into the first storage space according to the first storing path A.

In step S21, the transmitting sub-module 121 saves the standard configuration information of the computer into the first storage space according to the first storing path A.

In step S22, the predefining sub-module 120 sets the current reboot count M with 1. In step S23, the calculating module calculates the average startup time of the computer by utilizing the predefined calculation parameters.

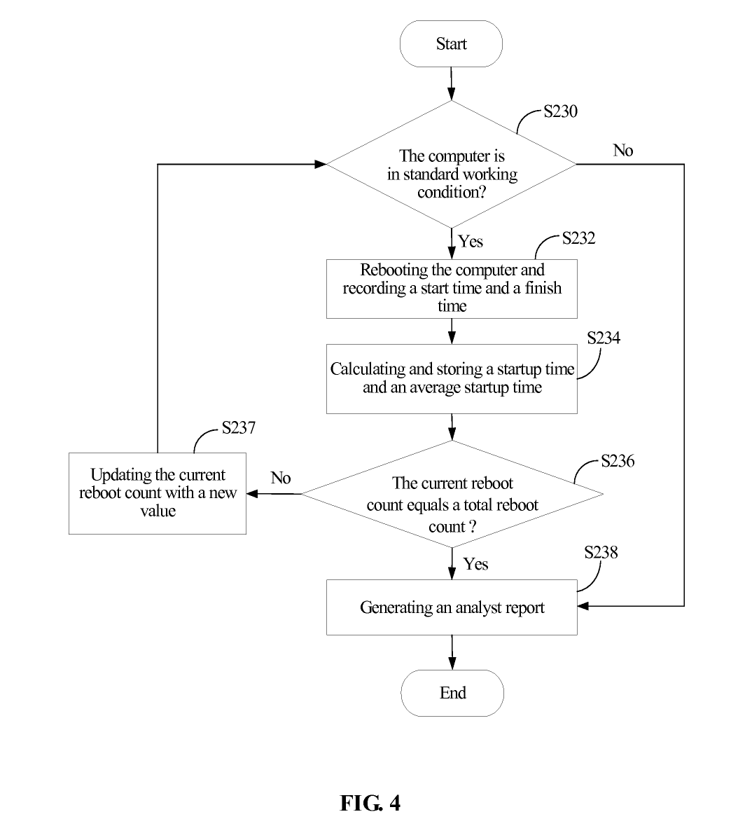

FIG. 4 is a flowchart of the step S23. In step S230, the rebooting sub-module 122 reads the configuring information of the computer before the computer is rebooted. The analyzing sub-module 123 analyzes whether the computer is in standard working condition by comparing the configuring information read with the standard configuration information.

If the computer is in standard working condition, in step S232, the rebooting sub-module 122 reboots the computer. The calculating sub-module 124 records the start time t_{M1} and the finish time t_{M2} after the computer is rebooted. The transmitting sub-module 121 saves t_{M1} and t_{M2} into the second storage space according to the second storing path B.

Otherwise, if the computer is not in standard working condition, in step S238, the calculating sub-module 124 generates the analysis report. The analysis report typically includes the longest startup time in all calculated startup times, the shortest startup time in all calculated startup times, the most recent startup time in the averaged startup time, and error information of the computer.

In step S234, the calculating sub-module 124 calculates the startup time T_{M} by subtracting t_{M1} from t_{M2} calculates the average startup time t_{M} by dividing the sum of all calculated startup times with the current reboot count M. The transmitting sub-module 121 saves T_{M} and t_{M} into the second storage space according to the second storing path B.

In step S236, the analyzing sub-module 123 analyzes whether the current reboot count M equals n. If the current reboot count M equals n, the procedure goes directly to step S238 described above. Otherwise, if the current reboot count M does not equal n, the calculating sub-module 124 increments M by 1, in step S237, to update the current reboot count M with a new value, and the procedure returns to step S230.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for calculating an average startup time of a computer, the system comprising:
a storage device for storing calculation data; and
a calculating module comprising:
a predefining sub-module configured for predefining a total reboot count, and for setting a current reboot count; and
a rebooting sub-module configured for rebooting the computer if the computer is in standard working condition and the current reboot count does not equal the total reboot count; and
an analyzing sub-module configured for analyzing whether the computer is in standard working condition according to standard configuration information of the computer, and for analyzing whether the current reboot count equals the total reboot count; and
a calculating sub-module configured for recording a start time and a finish time of rebooting the computer each time the computer is rebooted, for calculating a startup time by subtracting the start time from the finish time, for calculating an average startup time by utilizing all calculated startup times and the current reboot count, and for incrementing the current reboot count by a value to update the current reboot count with a new value if the current reboot count does not equal the total reboot count.

2. The system as claimed in claim 1, wherein the calculating module further comprises:
a transmitting sub-module configured for saving the total reboot count, the standard configuration information of the computer, the start time, and the finish time into the storage device.

3. The system as claimed in claim 2, wherein the calculation data comprises the total reboot count, the standard configuration information of the computer, the start time, and the finish time.

4. The system as claimed in claim 1, wherein the calculating sub-module is further configured for generating an analysis report if the computer is not in standard working condition.

5. The system as claimed in claim 4, wherein the calculating sub-module is further configured for generating the analysis report if the current reboot count equals the total reboot count.

6. The system as claimed in claim 5, wherein the analysis report comprises the longest startup time in all calculated startup times, the shortest startup time in all calculated startup times, the most recent startup time in averaged startup time, and error information of the computer.

7. A method for calculating an average startup time of a computer, the method comprising the steps of:
predefining a total reboot count;
setting a current reboot count;
rebooting the computer if the computer is in standard working condition;
recording a start time and a finish time of rebooting the computer after the computer is rebooted;
calculating a startup time by subtracting the start time from the finish time, calculating an average startup time by utilizing all calculated startup times and the current reboot count;
incrementing the current reboot count by a value to update the current reboot count with a new value if the current reboot count does not equal the total reboot count; and
rebooting the computer if the computer is in standard working condition.

8. The method as claimed in claim 7, further comprising the steps of:
generating an analysis report if the computer is not in standard working condition; or
generating the analysis report if the current reboot count equals the total reboot count.

9. The method as claimed in claim 8, wherein the analysis report comprises the longest startup time in all calculated startup times, the shortest startup time in all calculated startup times, the most recent startup time in averaged startup time, and error information of the computer.
